(19) United States
(12) Patent Application Publication
(10) Pub. No.: US 2006/0076101 A1
(43) Pub. Date: Apr. 13, 2006

(54) Method for decorating eggshells and article on egg decoration

(76) Inventor: Sergey Krivich, Brooklyn, NY (US)

Correspondence Address: KRIVICH Sergey, Apt.2B, 1730 East, 14 Street, Brooklyn, NY, 11229, US

(21) Appl. No.: 10/964,362

(22) Filed: Oct. 13, 2004

(51) Int. Cl. B29C 61/02; B32B 37/00

(52) U.S. Cl. 156/86; 264/132; 264/159; 264/230; 156/277

(57) ABSTRACT

A new method and article for drawing a decorative covering on the surface of avian eggs comprises next steps: applying to the egg parts of tubes made from heat shrinkable film with a layer of a decorative design covered the film and followed by thermal acting on the section of heat shrinkable film until it is tightly stretched over the surface of the egg.

### FIELD OF THE INVENTION

This invention relates generally to the decoration of avian eggs that have an impervious surface such as eggs and more particularly to the dyeing and decorating eggshells.

### BACKGROUND OF THE INVENTION

The use of decorated and decorative avian eggs for various festive occasions is well known in the arts. The most common usages of such eggs are in connection with Easter.

U.S. Pat. No. 4,181,745 provides a good overview for the known art.

Such known methods and apparatus include waxing of selected portions of the egg so that dyes may not affect the surface and afterwards removing portions of the wax to allow additional colors to be applied to the now unwaxed portions. Perhaps the best known method of this kind is referred to as Ukrainian egg dyeing. This method is extremely tedious but does result in extraordinary patterns.

Another method for egg decoration (see U.S. Pat. No. 2,074,376) includes the step of applying a layer of differently colored wax chips to the eggshell in the presence of sufficient heat to cause the chips to adhere to the shell and thus provide a mottled continuous coating. Still another method for egg dyeing is to immersion in an oil base, multi-color medium which is floated upon water: as the egg passes through this solution, it gets coated in a random design.

Another more common method is the simple dip process. In this method the egg is hard-boiled, a liquid dye solution is prepared, and the egg is simply immersed in the solution until the proper color is achieved (see U.S. Pat. No. 1,538,367). The waxing of portions of the egg will result in desired patterns.

Still another method for coloring eggs consists of a mechanical device in which the eggs are rotatably mounted, while colored pens are used to draw upon the surface (see U.S. Pat. No. 5,164,009). These pens are normally mechanically mounted and guided.

Although effective, these methods have disadvantages in that they allow no control of fine detail in the patterns and colorations on the egg surface. Another disadvantage of these methods is the difficulty of applying multiple colors to an egg at selected locations on the egg surface.

Moreover, all these methods are relatively expensive and require a lot of time.

Accordingly, it would be desirable to provide a method and article for egg decoration which eliminate and overcome such disadvantages.

### SUMMARY OF THE INVENTION

It is therefore an object of present invention to provide the method and article for drawing a decorative covering on the surface of avian eggs that would not be expensive or time-consuming.

According to the present invention the covering material is provided in the form of a substrate of tubular shape made of a heat-shrinkable film that is evenly distributed over the surface of the egg to be coated.

It is a further object of the present invention to provide the method and article for drawing a decorative covering on the surface of avian eggs that will be neither inexpensive and will be nor time-consuming.

In order to attain the above described objects it is provided a new method of producing of an element for drawing a decorative covering on a surface of avian eggs. This method comprises the following steps: printing a decorative patterns on rolls or sheets of a heat shrinkable film; cutting the decorated sheets into strips, forming these strips into tubes the perimeter (diameter) of which exceeds the perimeter of a cross-section of the egg; and cutting the tubes with the decoration on them into parts whose length is less or equal to the longitudinal length of the egg.

In order to attain the above described object it is provided a method for drawing a decorative covering on the surface of avian eggs This method comprises the following steps: printing a decorative patterns on rolls or sheets of a heat shrinkable film; cutting the decorated sheets into strips, forming these strips into tubes the perimeter (diameter) of which exceeds the perimeter of a cross-section of the egg; and cutting the tubes with the decoration on them into parts whose length is less or equal to the longitudinal length of the egg; applying the obtained parts on the egg and heat to the heat shrinkable film up to it stretched tightly over the surface of the eggshell. The heat shrinkable film is fully approved for contact with food. Heating on the eggs with the parts of heat shrinkable film applying around the surface of the egg may be applied through immersion them in hot water.

In order to attain the above described object it is provided an element for drawing a decorative covering on the surface of the avian eggs. The element comprises a substrate of tubular form made of a heat shrinkable film and a layer of a decorative covering on at least one side of said substrate. The element for drawing the decorative covering has at least one layer of decorative covering. At least one layer of said decorative covering is a monophonic colorful layer, a one-color monochrome layer and may comprise drawings selected from the group consisting of patterns, figures and pictures.

### BRIEF DESCRIPTION OF THE DRAWINGS

The accompanying drawings and disclosure will more fully illustrate the advantages of the present invention and its uses with these and other avian eggs. The same numeral is utilized to designate the same or similar elements throughout the several views, in which:

FIG. 1 is an illustration of a sheet of a heat shrinkable film with a layer of decorative design printed on a side of it;

FIG. 2 is a view of a tube formed from strips produced from sheets shown on FIG. 1;

FIG. 3 is a view of a part of the tube shown on FIG. 2 before it is applied to an egg;

FIG. 4 is an illustration of thermal acting upon the parts of heat shrinkable film on the egg; and

FIGS. 5a-5c are an illustration of the eggs with different decorations covering the surface.

### DETAILED DESCRIPTION OF THE INVENTION

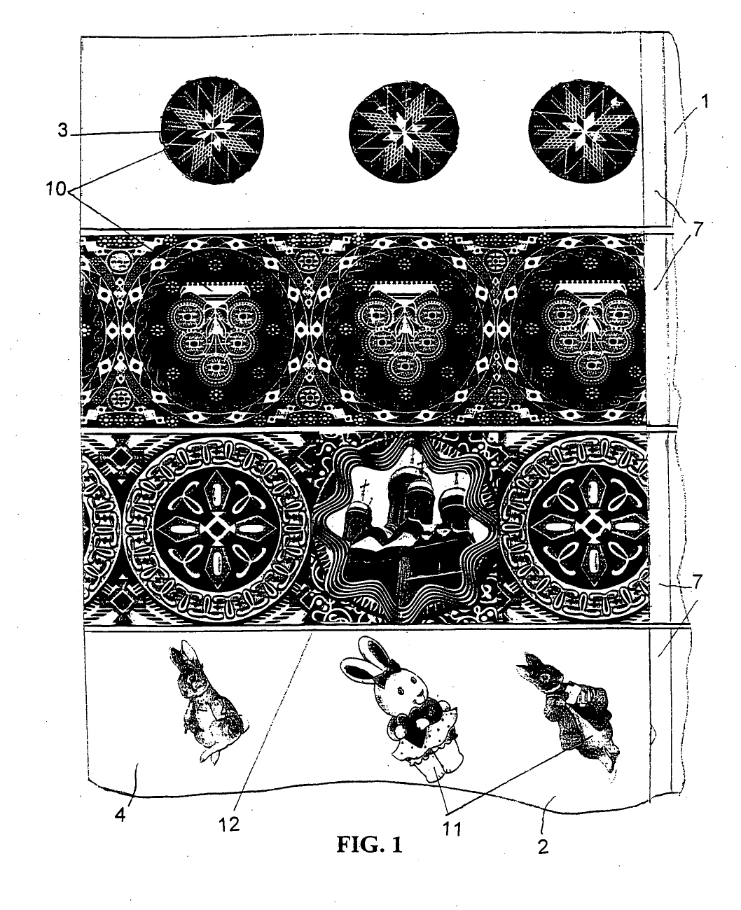

FIG. 1 shows sheet 1 of a heat shrinkable film and layer 2 with printing decor 3 on an upper side of the sheet 1. Sheet 1 of a heat shrinkable film may be made from the polyolefins and polyvinyl chlorides as described in the U.S. Pat. No. 4,188,443 full specification on which is incorporated therein by reference. These materials can be considered to be the two major families of plastic resins from which the bulk of commercially available shrink films for decorative covering on the surface is made. The shrinkable polyolefins currently on the market are mainly monolayer films. The polyvinyl chloride (hereinafter “PVC”) shrink films are monolayer films consisting of a variety of formulations of polyvinyl chloride. Sheet 1 of heat shrinkable film in the present invention has a thickness of 15 μm-80 μm, preferable 40 μm-50 μm. If thickness of the film 1 is less then 15 μm, the film will shrink rapidly, so that wrinkles, shrinkage spots and strains will be left after shrinkage and the films will easily be broken by outside impact after shrinkage. If thickness of film 1 is more then 80 μm, it leads to an increase in film weight, which deteriorates handling properties, and to an increase in production cost. The layer 2 with printing decor 3 on the upper side of sheet 1 may be a monophonic colorful layer 9 (a one-color, monochrome layer) or include drawings selected from the group consisting of a pattern 10, FIG. 11 and picture 12.

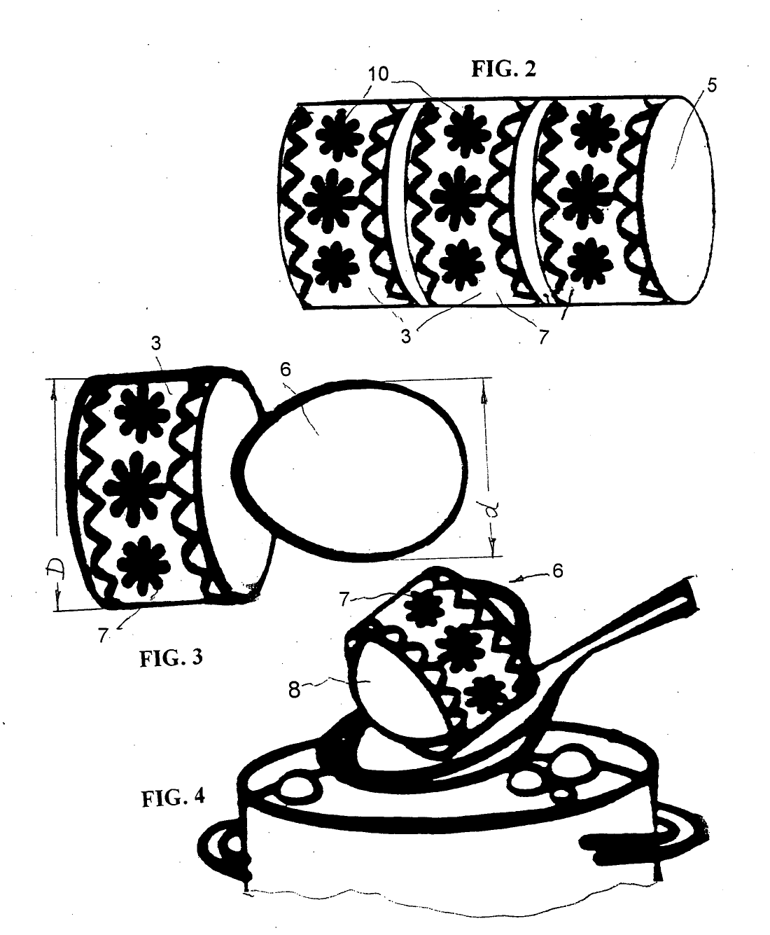

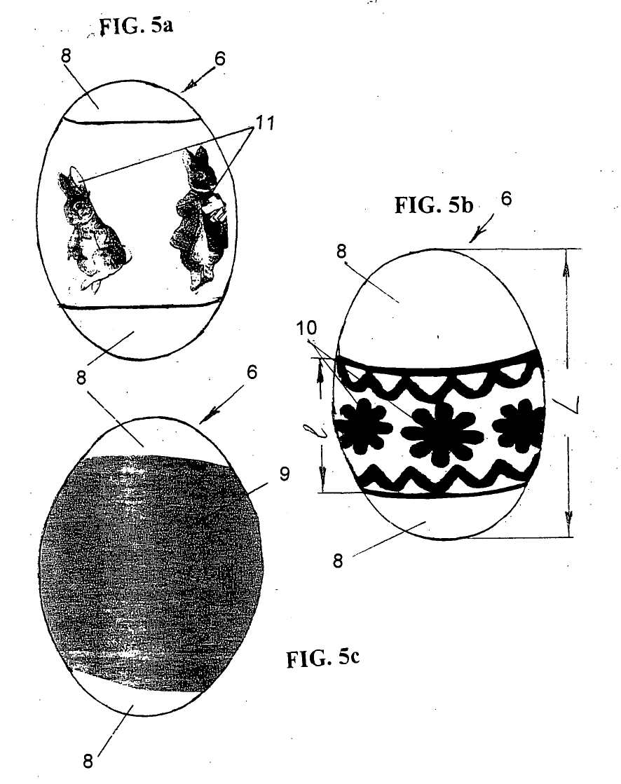

Sheet 1 of the heat shrinkable film and layer 2 with printing decor 3 on the upper side of sheet 1 are cut to produce strips 4 which may have different patterns 10, FIG. 11 and picture 12. Tubes 5 are formed from these strips 4 by any known methods (for example, by using adhesive, by welding) as shown on FIG. 2. Diameter “D” of tubes 5 exceeds diameter “d” of a cross-section of egg 6 (see FIG. 3). Tubes 5 with the decor 3 are cut to parts 7 (see FIGS. 1-3). Length “l” of parts 7 is less or equal to the longitudinal length “L” of egg 6 (see FIG. 5b). Because length l of parts 7 preferable is less (50%-70%) then the longitudinal length L of egg 6 parts 8 of eggs 6 are left uncover so us to improve the impression of the decorative covering on the surface of egg 6. The terms “eggs” as used herein means intact, unbroken eggs, preferably chicken eggs. The eggs used in the present invention should be originally lightly colored, preferably white. Prior to the drawing of decorative covering on the surface of the egg, the eggs should be hard-boiled, i.e. should be cooked in the shell in hot or boiling water until both white and yolk have solidified, in a vessel which minimizes discoloration of the egg surface. In one procedure, eggs are placed in a single layer in a pot, enough water is added to the pan to cover the eggs by an inch, the pot is covered and the water is quickly brought to a boil. The pot is removed from heat source so that the water no longer boils and the eggs are left to stand in hot water for about 15 to 17 minutes. Then, cold water is run over the eggs until they are cooled.

The method of drawing the decorative covering on the surface of the egg comprises next steps: putting on egg 6 parts 7 tubes 5 made of heat shrinkable film 1 with a layer 2 of a decor covered film 1 and thermal acting on parts 7 of heat shrinkable film 1 until it is stretched tightly over the surface of the egg. Thermal acting on parts 7 of heat shrinkable film 1 may be done by any known heat sources (microwave, heat radiation by the any other known equipment) and preferable through immersion for 3-5 seconds of eggs 6 in hot or boiling water with temperature measuring 85-100 degrees Celsius (see FIG. 4). After such thermal acting most of the middle part of egg 6 retained very nice decorative markings. The design of the decoration on the egg may be a monophonic colorful layer 9 as shown on FIG. 5c (monochrome layer) or include drawings selected from the group consisting of pattern 10 (FIG. 5b), FIG. 111 (FIG. 5a), and picture 12 as shown on FIG. 1. The shells of decorated eggs 6 may be broken by impact to uncovered parts 8. Heat shrinkable thin film 1 of the decorated covering easily comes off together with the broken shell.

The present invention's method and article for drawing the decorative covering on the surface of avian eggs is clean, inexpensive, and time-efficient.

Having described a specific preferred embodiment of the invention with reference to the accompanying drawings, it is important to note that the present invention is not limited to precise embodiment and that various changes and modifications can be effected therein by one of ordinary skill in the art without departing from the scope or spirit of the invention defined by the appended claims.

For example, one layer of heat shrinkable monophonic colorful film 1 can be used as a model for a monophonic colorful layer for decorating the surface of the egg or sheet of the heat shrinkable film may have layer with printing decor on the upper side of sheet and on the other side of sheet.

Similarly, the egg may be not only one specific object of the invention. Other objects that need decorative covering on the surface may benefit from the method and article of the present invention.

What is claimed is:

1. A method of producing of an element for drawing a decorative covering on a surface of avian eggs comprising the steps of:
(a). printing decorative patterns on rolls or sheets of a heat shrinkable film;
(B). cutting the decorated sheets into strips and subsequently forming tubes from these strips so that a perimeter (diameter) of each tube exceeds a perimeter of a cross-section of egg; and
(c) cutting the decorated tubes into parts whose length is less than or equal to longitudinal length of the egg.

2. A method of drawing of a decorative covering on a surface of avian eggs comprising the steps of:
(a). printing a decorative design on rolls or sheets of heat shrinkable film;
(B). cutting the decorated strips and formation from these strips subsequently forming tubes from these strips so that a perimeter (diameter) of each tube exceeds a perimeter of a cross-section of egg;
(c) cutting the decorated tubes into parts whose length is less than or equal to longitudinal length of the avian egg;
(d) applying the obtained parts to the egg; and
(e) thermally acting on the parts of the heat shrinkable film up to its dense stretched tightly over a surface of the avian egg.

3. The method of drawing of a decorative covering of claim 2 wherein the thermal acting on the parts of heat shrinkable film applied on egg being made by immersed them in hot water.

4. An element for drawing a decorative covering on a surface of avian eggs comprising a substrate of tubular form made of heat shrinkable film and a layer of a decorative covering on at least one side of said substrate.

5. The element for drawing a decorative covering of claim 4 wherein the layer of decorative covering is a monophonic colorful layer (a one-color, monochrome layer).

6. The element for drawing a decorative covering of claim 4 wherein the layer of decorative covering comprising drawings selected from the group consisting of patterns, figures and pictures.

7. A method of drawing a decorative covering on a surface of avian eggs, comprising the steps of:
(a). applying to the avian egg parts of tubes made from heat shrinkable film with a layer of a decorative design covering said film and
(b) thermal acting on the parts of heat shrinkable film until it is tightly stretched over a surface of the avian egg.

8. The method of drawing of a decorative covering of claim 7 wherein the avian eggs are hard boiled avian eggs.

9. The method of drawing a decorative covering of claim 7 wherein length of the parts is less then or equal to longitudinal length of the avian egg.

10. The method of drawing a decorative covering of claim 8 wherein the thermal acting on the eggs with the parts of heat shrinkable film dressed on its being made by immersing them in hot or boiling water.

11. The method of drawing of a decorative covering of claim 9 wherein the layer of decorative design comprising drawings selected from the group consisting of patterns, figures and pictures.
